(19) United States
(12) Patent Application Publication
(10) Pub. No.: US 2003/0114332 A1
(43) Pub. Date: Jun. 19, 2003

(54) Unit dose products

(75) Inventors: Sachindew Manodjkoemar Ramcharan, Vlaardingen (NL); Zaida M. Salazar, Vlaardingen (NL); Pieter Broer Van Der Weg, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/315,867

(22) Filed: Dec. 10, 2002

(30) Foreign Application Priority Data
Dec. 14, 2001 (GB) 0129983.3

(51) Int. Cl. C11D 17/00

(52) U.S. Cl. 510/296; 510/297; 510/295; 510/439

(57) ABSTRACT

A unit dose detergent product comprising a liquid detergent composition contained in a pouch formed of a water soluble polymer film, at least one solid member being immersed in said composition, the rate of dissolution of the solid member in the composition at a storage temperature being greater than the rate of dissolution of the polymer film in the composition at the storage temperature.

### TECHNICAL FIELD

The present invention relates to a unit dose product for laundering of textile fabrics by hand or machine.

### BACKGROUND TO THE INVENTION

It is well known to include visually contrasting particles, for example, coloured speckles, lammellae, pastilles, or noodles, in detergent powders, liquids and tablets for laundering of textile fabrics. These may be included as a cue to the consumer, to indicate the presence of some specific ingredient or benefit, for example, bleach or fabric care property, or may simply be present to give the product an attractive appearance.

In the case of liquid laundry detergent products for the washing or rinsing of textile fabrics, there has been a trend to provide them in unit dose pouches formed of water soluble film containing the liquid, instead of in bulk in a bottle or pouch. The appeal of such products is convenience and cleanliness of handling, as well as easy determination of the correct dose. Normally, one or two capsules are simply placed in the washing machine with the fabrics. The film is normally translucent or transparent.

Water soluble packages for liquid detergent compositions are known, including packages made from polyvinyl alcohol (PVA) film, for example U.S. Pat. No. 4,973,416.

### DEFINITION OF THE INVENTION

A first aspect of the present invention provides a unit dose detergent product comprising a liquid detergent composition contained in a pouch formed of a water soluble polymer film, at least one solid member being immersed in said composition, the rate of dissolution of the solid member in the composition at a storage temperature being greater than the rate of dissolution of the polymer film in the composition at the storage temperature.

A second aspect of the present invention provides a unit dose detergent product comprising at least a first liquid phase and a second liquid phase, separate liquid phases, at least one of which liquid phases is a liquid detergent composition, the liquid phases being contained in a pouch formed of a water soluble polymer film, at least one solid member being immersed in at least one of the liquid phases.

### DETAILED DESCRIPTION OF THE INVENTION

The Solid Member

At least one solid member is immersed in the liquid detergent composition. In accordance with the first aspect of the invention, the rate of dissolution of the solid member at a (reference) storage temperature is greater than the rate of dissolution of the polymer film in the composition at the storage temperature.

One way in which this can be achieved is if the member is formed so as to comprise a piece of polymer film of substantially the same material as the polymer film which forms the pouch and has a thickness which is the same as or less than that of the film which forms the pouch. A piece of such film which is of the same thickness will still dissolve more rapidly than the polymer film of the pouch, because it will be exposed on both sides to the liquid detergent composition. Of course, the polymer film of the pouch is only exposed to the composition on the inside.

Another means of ensuring that the solid member dissolves at a greater rate than the polymer film of the pouch, is if it is made of, or contains, a material having a greater solubility than the polymer film which forms the pouch. This may for example, be a polymer material of different composition than the polymer material of the pouch. As used herein, the term “polymer” includes copolymers made of a mixture of two or more different monomer units.

The solid member(s), may for example be selected from visually contrasting bodies in the form of lamellae, speckles, noodles and mixtures thereof. The solid member(s) may or may not contain functional ingredients having a beneficial effect in the wash.

The solid members preferably also provide a visual contrast, in colour, shape and/or size, to the bulk of the liquid detergent composition, to emphasize visual impact.

Visually contrasting solid members are preferably formed of brightly coloured material, which may if desired be fluorescent. Advantageously the material is highly reflective (shiny). When there is a plurality of solid members, they may be the same or of differing colour(s).

Any solid member is preferably regular in shape. It may suitably possess a relatively high degree of symmetry. However some aesthetically pleasing shapes may not be highly symmetrical.

Lamellae may suitably have symmetrical and regular shapes, such as circles, squares, triangles, and stars. All lamellae may be of the same shape and colour, or different shapes and colours may be used together. The lamellae may be of identical size, or of several different, but discrete, sizes.

As an alternative to the use of identical shapes, matched sets of shapes may be used, for example, geometrical shapes (triangles, squares, pentagons, hexagons), numerals, letters of the alphabet, heavenly bodies (sun, moon, stars). Congruent sets having the same shape but different sizes may also be used. Each may have its own colour.

The solid member(s) preferably need be present only at very low concentrations, for example, 0.02 to 1 wt %, preferably from 0.05 to 0.5 wt %, based on the weight of the liquid detergent composition, in order to make a significant visual impact. One larger body with a diameter between 10% and 90% of the diameter of the laundry unit dose capsule will already create a clear visual sign.

The Water Soluble Pouch

The water-soluble pouch is formed from a water-soluble polymer film and contains the liquid detergent composition.

Any reference herein to filling refers to complete filling and also partial filling whereby some air or other gas is also trapped in the sealed envelope.

The envelope forming the package is preferably formed by horizontal or vertical form-film-seal technique.

The Water Soluble Polymer Film

As used herein, the term “water soluble polymer” refers to a polymer which dissolves and/disperses completely in water within 30 minutes with agitation, e.g. by means of hand, stick or other stirrer or under the action of a mechanical washing machine and at a relevant temperature. A “relevant temperature” is one at which the consumer will need to dissolve or disperse the polymer component at the beginning of, or during a cleaning process. A polymer is to be regarded as dissolving or dispersing at a “relevant temperature” if it does so under the aforementioned conditions at a temperature anywhere in the range of from 20° C. to 60° C.

Preferred water soluble polymers are those capable of being cast into a film or solid mass and may for example as described in Davidson and Sittig, Water-Soluble Resins, Van Nostrand Reinhold Company, New York (1968). The water-soluble polymer should have proper characteristics, such as strength and heat-sealability, to permit machine handling during the processes of making the water soluble package. Preferred water-soluble resins include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water-soluble, polyvinyl alcohol film-forming resins are preferred.

Polyvinyl alcohols preferred for use therein have an average molecular weight anywhere between 1,000 and 1,000,000, preferably between 5,000 and 250,000, for example between 15,000 and 150,000. Hydrolysis, or alcoholysis, is defined as the percent completion of the reaction where acetate groups on the resin are substituted with hydroxyl, —OH, groups, A hydrolysis range of from 60-99% of polyvinyl alcohol film-forming resin is preferred, while a more preferred range of hydrolysis is from about 70-90% for water-soluble, polyvinyl alcohol film-forming resins. The most preferred range of hydrolysis is 80-89%. As used in this application, the term “polyvinyl alcohol” includes polyvinyl acetate compounds with levels of hydroloysis disclosed herein. The water-soluble resin film should be formulated so as to substantially completely dissolve in 50° C. water with agitation within about thirty minutes, preferably within about 15 minutes in 50° C. water with agitation, and most preferably within about 5 minutes in 50° C. water with agitation.

An especially preferred plastics film is a polyvinyl alcohol film, made of a polyvinyl alcohol copolymer having a comonomer having a carboxylate function.

PVA can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVA films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVA films for use in a package according to the invention are commercially available and described, for example, in EP-B-0 291 198. PVA films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

Plasticiser

The film may incorporate a plasticiser.

The water soluble film may be formed from a variety of different materials. The plasticiser will depend on the nature of the film in question. Preferred plasticisers are recited in more detail in the section of this description dealing with these film materials. One or more plasticisers may independently be incorporated in the film and in the liquid composition. However, it is very much preferred for the identity of the plasticiser(s) in the film and in the liquid composition to be substantially the same.

The plasticiser system influences the way the polymer chains react to external factors such as compression and extensional forces, temperature and mechanical shock by controlling the way that the chains distort/realign as a consequences of these intrusions and their propensity to revert or recover to their former state. The key feature of preferred plasticisers is that they are highly compatible with the film, and are normally hydrophilic in nature.

Generally speaking, plasticisers suitable for use with PVA-based films have —OH groups in common with the ˜CH₂—CH(OH)—CH₂—CH(OH)-polymer chain of the film polymer.

Their mode of functionality is to introduce short chain hydrogen bonding with the chain hydroxyl groups and thus weaken adjacent chain interactions which inhibits swelling of the aggregate polymer mass—the first stage of film dissolution.

However, many plasticisers are suitable both for PVA-films and films of many other types. Water itself is a suitable plasticiser for any of the films recited herein but other common plasticisers include:

Polyhydroxy compounds, e.g. glycerol, trimethylolpropane, diethylene glycol, triethylene glycol, dipropylene glycol

Starches e.g. starch ether, esterificated starch, oxidized starch and starches from potato, tapioca and wheat

Cellulosics/carbohydrates, e.g. amylopectin, dextrin carboxymethylcelluose and pectin.

The amount of plasticiser per unit weight of film may vary considerably according to the film type and plasticiser type(s). It could, for example be in the range of from 0.1% to 50%, e.g. 10% to 45%, such as 20% to 40% by weight.

Polyvinylpyrrolidone is (PVP), another preferred polymer for use in the articles of the present invention. Dried, unmodified films of PVP are clear or transparent, glossy and reasonably hard. Modifiers may be used in concentrations of 10 to 50% to control tack, brittleness or to decrease the hygroscopicity. Unmodified PVP films are relatively very hygroscopic in character, and moisture taken up from the air can also act as plasticiser. Other plasticisers are for example glycerol, propylene glycol, diethylene glycol and sorbitol. These tend to increase tackiness of the PVP film. Carboxymethylcellulose or cellulose acetate can be used to decrease tackiness. Films essentially tack-free over all ranges of relative humidity may be also obtained by incorporation of 10% arylsulfonamide-formaldehyde resin.

Preferred water-soluble films may also be prepared from polyethylene oxide (PEO). High molecular weight polymers of ethylene oxide with molecular weight of about 100,000 to 5,000,000 form strong, translucent, thermoplastic films. Unfunctionalised films of these resins easily crack when only minor stress is applied (a process known as ‘stress cracking’). This is accelerated by exposure to ultraviolet radiation but can be slowed down or inhibited completely by the addition of plasticisers in combination with suitable UV radiation inhibitors. Suitable plasticisers are for example (low molecular weight) polyethylene glycol and polypropylene glycol, carbohydrates, glycerol, organic and inorganic esters such as glycerol triacetate or triethyl citrate.

PEO films generally have very good mechanical properties and heat sealability, combined with complete water solubility. In comparison with other commonly used water-soluble films, polyethylene oxide films offer the advantage of good compatibility.

Further examples of suitable water soluble polymers are modified celluloses, such as methylcellulose (MC) and hydroxypropylmethylcellulose (HPMC). These yield high-strength, clear, water-soluble films that are impervious to many organic and petroleum-based solvents. The mechanical properties can be modified by a number of plasticisers, such as glycerol, propylene glycol, sorbitol, diethylene glycol, triethanol amine, and N-acetyl ethanol amine. Properly plasticised MC or HPMC sheeting products can be sealed at about 130° C. using standard sealing equipment.

An alternative cellulose-based material is hydroxypropyl cellulose (HPC). Clear, flexible films of this material may be prepared from aqueous or organic solvent solutions of the polymer. An advantage of HPC is that it has good plastic-flow properties enabling it to be thermoformed into flexible film articles without the aid of plasticisers or other additives. They are non-tacky even at high humidity. The unplasticised film has good cold water solubility but is insoluble in water>45° C.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

Blends (i.e. not copolymers) of two or more polymers recited herein, may also be used.

Encapsulation Methods

(a) Horizontal Form-Fill-Seal

Water soluble based on PVA can be made according to any of the methods horizontal form-fill-seal described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of polyvinyl alcohol film is drawn over a forming die so that the film is placed over the plurality of forming cavities in the die. In this example each cavity is generally dome shape having a round edge, the edges of the cavities further being rounded to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 0.5 bar is pulled through the pre-heating plate to ensure intimate contact between the film and the pre-heating plate, this intimate contact ensuring that the film is heated evenly and uniformly (the extent of the vacuum is dependent of the thermoforming conditions and the type of film used, however in the present context a vacuum of less than 0.6 bar was found to be suitable) Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. At this time, the solid member(s) may also be introduced. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The rounded edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

(b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

Encapsulation methods for other water soluble films such as based on PVP or PEO will be known to those skilled in the art.

Unit Dose Volume

The amount of the substantially non-aqueous liquid cleaning composition is each unit dose envelope may for example be from 10 ml to 100 ml, e.g. from 12.5 ml to 75 ml, preferably from 15 ml to 60 ml, more preferably from 20 ml to 55 ml.

The Liquid Detergent Composition

The liquid detergent composition, may be substantially aqueous, substantially non-aqueous or substantially semi-aqueous. It may comprise two or more separate planes or layers, e.g. of differing densities.

Non-Aqueous Liquids

A substantially non-aqueous liquid cleaning composition must contain at least one non-aqueous liquid. Further, the non-aqueous liquid itself and/or another component of the composition must provide a cleaning function when released into the wash liquor.

By “substantially non-aqueous” it is meant that that the amount of water in the liquid composition is below the level at which the package would dissolve through contact with its contents. Preferably, the liquid composition comprises 25%, e.g. no more than 20%, more preferably no more than about 15%, still more preferably no more from 10%, such as no more than about 7%, even more preferably no more than about 5% and most preferably no more than from about 3% to about 4%, by weight water. However, in some cases, it may be possible (whether by reason of the thickness of the film used, the physical properties, such as viscosity, of the liquid composition or otherwise) to use even higher quantities of water in the liquid composition inside the package according to the invention, although these should never exceed 50% by weight of the liquid composition.

The substantially non-aqueous liquid composition may be substantially Newtonion or else non-Newtonion in rheology. The latter especially applies when the composition comprises dispersed solids. Therefore, for the avoidance of doubt, all viscosities expressed herein are measured at a shear rate of 21 s⁻¹.

The viscosity of the composition is preferably from 25 mPaS, 50 mPaS, 75 mPaS or 100 mPaS, preferably 125 mPaS, more preferably 150 mPaS to 10,000 mPaS, for example above 150 mPaS but no more than 10,000 mPaS. The alternative embodiment of the invention relates to VFFS encapsulation in which case, the minimum viscosity must be 10 mPaS, for example above 150 mPaS.

The composition may be considered as falling into the sub-classes of thin liquids, thick liquids, and gels/pastes.

The thin liquids may have a minimum viscosity of 25, 50, 75, 100, 125, 150 mPaS or above 150 mPaS for example 175 mPaS, preferably 200 mPaS. They may for example have a maximum viscosity of 500 mPaS preferably 450 mPaS more preferably 400 mPaS or even 250 mPaS.

The thick liquids may have a minimum viscosity of 400 mPaS, for example 350 mPaS, or even 300 mPaS and a maximum viscosity of 1,500 mPaS, preferably 1,200 mPaS.

The gels or pastes may have a minimum viscosity of 1,400 mPaS, for example 1,500 mPaS, preferably 1,750 mPaS, 2000 mPaS, 2,500 mPaS, 3,000 mPaS or even 3,500 mPaS. Their maximum viscosity may be 10,000 mPaS, preferably 9,000 mPaS, more preferably 8,000 mPaS, 7,500 mPaS or even 4,000 mPaS.

The non-aqueous liquid may comprise one or more non-aqueous liquid components. These may be one or more liquid surfactants and/or one or more non-aqueous non-surfactant liquids.

Suitable liquid surfactants liquid nonionic surfactants.

Nonionic detergent surfactants are well-known in the art. They normally consist of a water-solubilizing polyalkoxylene or a mono- or d-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having from 10 to about 24 carbon atoms in the alkyl group and polyoxypropylense. Also common are fatty acid mono- and dialkanolamides in which the alkyl group of the fatty acidradical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

Suitable non-aqueous non-surfactant liquids forms can be used alone or with in combination with liquid surfactants. Non-surfactant solvents which are more preferred category include ethers, polyethers, alkylamines and fatty amines, (especially di- and tri-alkyl- and/or fatty-N-substituted amines), alkyl (or fatty) amides and mono- and di-N-alkyl substituted derivatives thereof, alkyl (or fatty) carboxylic acid lower alkyl esters, ketones, aldehydes, polyols, and glycerides.

Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents are lower (C₁₋₄) alcohols, such as ethanol, or higher (C₅₋₉) alcohols, such as hexanol, as well as alkanes and olefins. However, they can be combined with other solvent materials which are surfactants and non-surfactants having the aforementioned “preferred” kinds of molecular structure. Even though they appear not to play a role in the deflocculation process of dispersed solids, it is often desirable to include them for lowering the viscosity of the product and/or assisting soil removal during cleaning.

Preferably, the compositions of the invention contain the organic solvent (whether or not comprising liquid surfactant) in an amount of at least 10% by weight of the total composition. The amount of the solvent present in the composition may be as high as about 90%, but in most cases the practical amount will lie between 20 and 70% and sometimes, between 20 and 50% by weight of the composition. The weight ratio of surfactant to non-surfactant non-aqueous liquid components is preferably from 0:10 to 10:0, more preferably from 1:10 to 10:1, still more preferably from 1:6 to 6:1, yet more preferably from 1:5 to 5:1, e.g. from 1:3 to 3:1.

Whether or not the composition contains nonionic surfactant, one or more other surfactants may be present. These may be in liquid form or as solid dissolved or dispersed in the substantially non-aqueous liquid component. They may be selected from anionic cationic and ampholytic detergent surfactants. The anionic surfactants may be incorporated in free acid and/or neutralised form. The cationic surfactant may be neutralised with a counter ion or it may be used as stabilising compound to neutralise the at least one ionic ingredient with an exchangeable hydrogen ion.

The composition may also comprise one or more solid dissolved and/or dispersed in the substantially non-aqueous liquid. When these are dispersed solids, it is preferred also to include one or more deflocculating agents as described in EP-A-0 266 199.

Some of these ingredients may be of an acidic nature, such as soaps or the acid precursors of anionic surfactants (which can be used for their surfactant properties and/or as deflocculants). These materials have an exchangeable hydrogen ion. As already mentioned, according to our copending but unpublished application PCT/EP01/03770, when the liquid composition comprises at least one “acidic” component having an exchangeable hydrogen ion, and the film is a PVA film including carboxyl-functional co-monomers, it is preferred to substantially neutralise or over-neutralise this component with a stabilising compound. This is to solve the following problem.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

However, when the resultant copolymer film contains carboxylic acid or carboxylate groups (either of these hereinafter being referred to as “carboxylate functionality”) in proximity to hydroxyl groups on the same carbon chain and there is an attendant drive towards cyclisation of these groups by water elimination to form lactones. A low level of lactone formation is desirable to improve the mechanical properties of the film. However, the formation of excessive amounts of lactones is undesirable as this tends to reduce the cold water solubility of the film, giving rise to a danger of undissolved film residues when the package is used.

The problem of excessive lactone formation is particularly acute when the liquid composition inside the package comprises ionic species. This is thought to be because the presence of ionic species can give rise to exchange between sodium ions (associated with carboxylate groups) in the film and hydrogen ions in the liquid composition. Once such exchange has occurred, the resulting carboxylic acid group in the film can cyclise with a neighbouring hydroxyl group, eliminating water in the process, thus forming lactones.

The Ionic Ingredient with Exchangeable Hydrogen Ions

When present, the ionic ingredient with exchangeable hydrogen ions may, for example, constitute from between 1% and 40% (prior to any neutralisation) by weight of the total substantially non-aqueous liquid composition. When used primarily for their surfactant properties, such ingredients may for example be present in amounts greater than 10% by weight. When used as deflocculants (see below), the amounts may be 10% by weight or less, e.g. no more than 5% by weight. These ingredients may for example be selected from anionic surfactant acid precursors and fatty acids and mixtures thereof.

Anionic surfactant acids are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used. Examples of suitable fatty acids include oleic acid, lauric acid or hardened tallow fatty acid.

Stablilising Compound

The provision of a molar excess (with respect to the amount of exchangeable hydrogen ions in the at least one ionic ingredient) of the stabilising compound in the liquid composition is found to have a significant effect in maintaining the cold water solubility of the film through the hindrance of lactone formation. However, in the case of inorganic bases and/or ammonium hydroxide forming all or part of the stabilising compound, the amount of stabilising compound need not be in excess, provided it is at least 95 mole % of the amount needed for full neutralisation. Surprisingly, the hindrance of lactone formation is significantly greater when these amounts of stabilising compound is used than when a molar equivalent or less is used. This advantageous effect is particularly marked after prolonged storage (e.g. for several weeks) of the package according to the invention at elevated temperature (e.g. 37° C.), conditions which are frequently encountered by some commercial products in European and other markets.

The problem of excessive lactone formation is particularly acute when the liquid composition inside the package comprises ionic species having an exchangeable hydrogen ion, for example fatty acids or the acid precursors of anionic surfactants.

This problem may be solved by including in the composition, a stabilising compound effective for combining with the exchangeable hydrogen ions to hinder the formation of lactones within the film. This stabilising compound should preferably be in molar excess relative to the component(s) having an exchangeable ion. This molar excess is preferably up to 105 mole %, preferably up to 110 mole % of the stoichiometric amount necessary for complete neutralisation. It is preferably an organic base such as one or more amines, e.g. monoethanolamine, triethanolamine and mixtures thereof. When the stabilising compound is or comprises an inorganic base such as an alkali metal (e.g. sodium or potassium) hydroxide, or ammonium hydroxide, it may, however, present in an amount as low as 95 mole %, e.g. from 95 mole % to 105 mole % relative to the component(s) having an exchangeable hydrogen ion.

In other aspects of the invention, for the stabilising compound, instead of the 95 mole %, we may claim as minimum, any of 90, 91, 92, 93, 94, 94.4, 96, 96.5, 97, 97.5, 98, 98.5, 99 and 99.5 mole %. Also, independently of any particular minimum, in other aspects of the invention, as maximum, we may claim any of 100.25, 100.5, 101, 101.5, 102, 102.5, 103, 103.5, 104, 105, 106, 107, 108, 109 and 110 mole %.

Other possible inorganic stabilising compounds are alkaline earth metal hydroxides or other inorganic bases which do liberate water on protonation. These are preferably also used in an amount indicated above for the alkali metal hydroxides and ammonium hydroxide.

Yet other suitable stabilising compounds are amines other than monoethanolamine and triethanolamine, and organic Lewis bases or other organic or inorganic bases provided that they will interact effectively with labile protons within the detergent composition to hinder the production of lactones in the film.

Multiphase Liquids

Liquids may comprise two or more phases, for example with different textures or colours. For example, a colourless liquid and a blue liquid.

The presence of two phases is an essential feature of the second aspect of the invention.

Other Components

The substantially non-aqueous liquid cleaning composition may further comprise one or more ingredients selected from non-ionic or cationic surfactants, builders, polymers, fluorescers, enzymes, silicone foam control agents, perfumes, dyes, bleaches and preservatives.

Some of these materials will be solids which are insoluble in the substantially non-aqueous liquid medium. In that case, they will be dispersed in the substantially non-aqueous liquid medium and may be deflocculated by means of one or more acidic components such as selected from inorganic acids anionic surfactant acid precursors and Lewis acids, as disclosed in EP-A-266 199, as mentioned above.

The invention will now be more particularly described with reference to the following preferred embodiments and examples, and with reference to the accompanying drawings in which:

### BRIEF DESCRIPTION OF THE DRAWINGS

FIG. 1 shows a photograph of shapes of various solid members which can be used in performance of the present invention;

FIG. 2 shows a photograph of a biphasic liquid usable as a liquid detergent composition in a product according to the present invention; and

FIG. 3 shows a photograph of the composition of FIG. 2 in which is floating, one of the solid member of FIG. 1, this combination being usable in a product according to the present invention.

### EXAMPLES

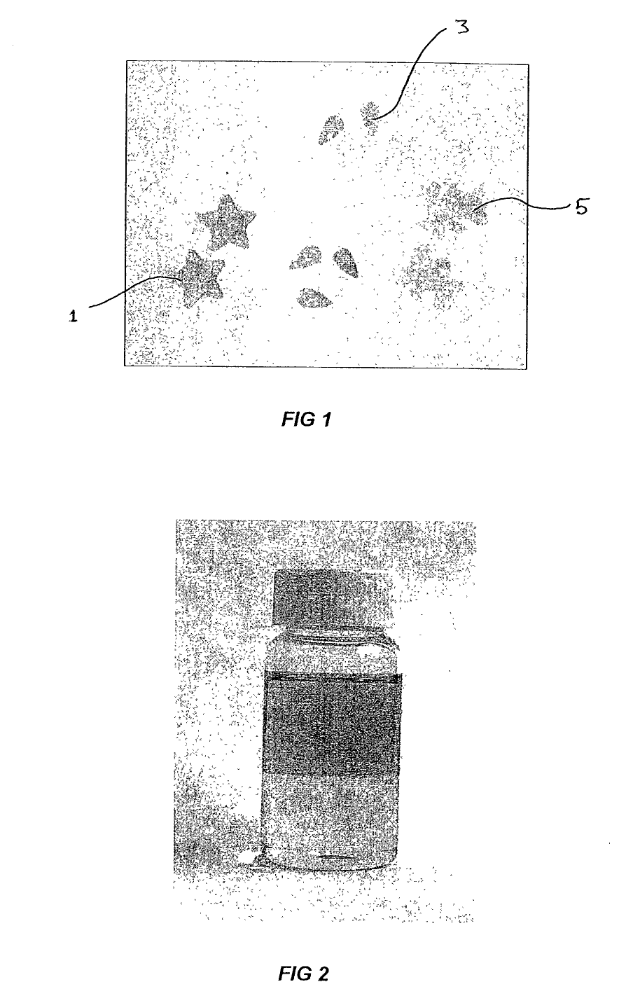

FIG. 1 shows several shapes of bodies that are visually attractive and can be included in a liquid unit product according to the present invention. They comprise stars 1, teardrops 3 and teddy bears 5.

These are made from a water-soluble (Klucel™ GFF ex Aqualon) cellulosic film with sizes ranging from 7 to 14 mm. They are coloured with a few drops of aqueous food colour and dried. In alternative examples, finely divided pigment or dye may be dispersed in the film. The film can alternatively be made opaque in gradation transparent to white with aqueous titanium dioxide of varying strength (9-25 wt % titanium oxide).

FIG. 2 shows a photograph of a bilayer liquid detergent composition which has aesthetic appeal to consumers.

The composition has two layers with a volume ratio (1:1), and a water activity of 0.45.

The top layer is blue/green transparent, the lower layer almost colourless/transparent.

The composition is made by bringing together two components:

| | Concentration |
|---|---|
| Component 1 | wt % |
| Neodol1-5 nonionic surfactant | 60.0 |
| Alkylbenzene sulphonic acid | 20.0 |
| Monoethanolamine | 4.0 |
| Monopropylene glycol | 9.9 |
| Water | 6.0 |
| blue dye | 0.1 |

| | Concentration |
|---|---|
| Component 2 | Wt % |
| Monoethalolamine citrate salt | 80.0 |
| Water | 20.0 |

FIG. 2 shows the bilayer liquid composition from FIG. 2 in which the teddy bear film body of FIG. 1 floats at interface between the two components. The bear floats between the two layers. After shaking, the layers separate and the bear returns from the top layer to the interface (bear mainly resides in the top liquid).

### Example 1

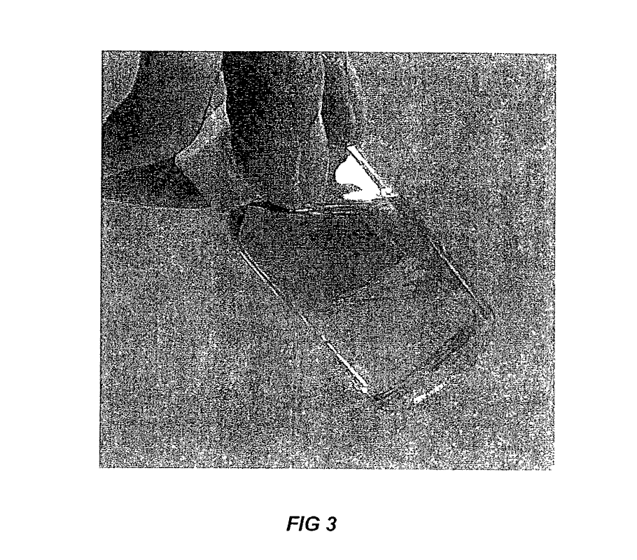

The liquid composition shown in FIG. 2 with the bear film body immersed in it as shown in FIG. 3, was packaged in a water-soluble capsule made of polyvinylalcohol-based film. The total liquid film fill volume was 25 ml. The film used to form the capsule had the same volume as the film used to form the teddy bear. Upon prolonged storage at 25° C., the bear film body dissolved before the capsule degraded to a degree when it ruptures.

1. A unit dose detergent product comprising a liquid detergent composition contained in a pouch formed of a water soluble polymer film, at least one solid member being immersed in said composition, the rate of dissolution of the solid member in the composition at a storage temperature being greater than the rate of dissolution of the polymer film of the pouch in the composition at the storage temperature.

2. A product according to claim 1, wherein the solid member is comprised of a polymer film of substantially the same material as the polymer film which forms the pouch and has thickness the same as or less than that of the film of the pouch.

3. A product according to claim 1, wherein the solid member is comprised of a material having a greater solubility than the polymer film of the pouch.

4. A product according to claim 3, wherein the material is a polymer material.

5. A product according to claim 1, wherein said composition is a substantially non-aqueous liquid detergent composition.

6. A product according to claim 1, wherein said composition is a first liquid phase, separate from a second liquid phase also contained within the pouch.

7. A product according to claim 6, wherein the solid member has a density more than the density of the first phase and less than the density of the second phase.

8. A composition according to claim 1, wherein the solid member is coloured and/or reflective.

9. A composition according to claim 1, wherein said storage temperature is in the range from 10° C. to 37° C.

10. A unit dose detergent product comprising at least a first liquid phase and a second liquid phase, separate liquid phases, at least one of which liquid phases is a liquid detergent composition, the liquid phases being contained in a pouch formed of a water soluble polymer film, at least one solid member being immersed in at least one of the liquid phases.
